(19) United States
(12) Patent Application Publication
(10) Pub. No.: US 2007/0246601 A1
(43) Pub. Date: Oct. 25, 2007

(54) Manned/unmanned V.T.O.L. flight vehicle

(76) Inventor: Otis Franklin Layton, Bonney Lake, WA (US)

Correspondence Address: Otis Layton, P.O. Box 7442, Bonney Lake, WA, 98391, US

(21) Appl. No.: 11/245,580

(22) Filed: Oct. 7, 2005

Related U.S. Application Data
(60) Provisional application No. 60/616,831, filed on Oct. 7, 2004.

(51) Int. Cl. B64C 29/00

(52) U.S. Cl. 244/12.2

(57) ABSTRACT

A manned/unmanned, autotonomously or remotely directed, horizontal, or vertical take-off and landing (HOVTOL) aircraft. This air vehicle incorporates multiple vertical facing ducted fans (shrouded propellers) driven by at least one power plant. Control authority of said air vehicle when in vertical flight mode is maintained through varying and vectoring the thrust produced by said ducted fans. When in a conventional horizontal flight mode, the aircraft would rely on aerodynamic control surfaces. In one embodiment this air vehicle would have the ability to transition from vertical helicopter type flight to a conventional horizontal aircraft mode of flight and back again. In another embodiment, this aircraft would perform similar to a helicopter—using only its ducted fans to produce vertical lift and maneuver in three dimensions.

This non-provisional utility patent application claims the benefit of provisional patent No. 60/616,831 filed on Oct. 7, 2004.

### BACKGROUND OF INVENTION

Typically modern aircraft are divided into two flight classifications, one being fixed wing (airplanes), the other being rotary wing (helicopters). The present invention relates to an air vehicle that in a preferred embodiment would have the characteristics of both aircraft. This type of aircraft is commonly known as a HOVTOL (horizontal or vertical take-off and landing) air vehicle.

Currently there are several aircraft that are classified in the HOVTOL category, these include but are not limited to: French Nord 500, Ryan XV-5A, Lockheed Hummingbird, Lockheed X-35B, and the British Harrier Jet. In a similar category classified as VTOL (vertical take-off and landing) there are several successful examples, these include: Boeing-Bell V-22, Bell Eagle Eye UAV, Convair XFY1 Pogo, Lockheed XFV1, Hiller Ryan XC142.

These mentioned aircraft, and many more, applied a variety of methods to attain their vertical lift function. These methods are; diverted jet thrust, tilt wing, tilt rotor, rotary wing, fan in wing, direct jet thrust and ducted fan thrust. Several patents that cover these principles include: U.S. Pat. No. 3,912,201, U.S. Pat. No. 5,209,428, U.S. Pat. No. 3,080,137, and U.S. Pat. No. 2,940,691.

The most successful of these VTOL categories is the rotary wing, more commonly known as the helicopter. Although it has reached utilitarian status, the helicopter has multiple limitations, these include; a limited horizontal speed envelope, rotor strike safety concerns and multiple complex mechanical features.

Although not as efficient as the large exposed rotor blades of the helicopter, the ducted fan (shrouded propeller) offers several advantages, these include; (when mounted in an aerodynamic wing like structure) a large speed envelope, minimal blade strike safety issues, simple mechanical coupling, inherent stability, multiple design options and transitional flight capabilities. It is the principle object of this invention to provide an aircraft (manned or unmanned) with HOVTOL capabilities, as well as meet performance and safety criteria, without limiting platform flexibility.

### SUMMARY OF INVENTION

It is the intent of this invention to provide a VTOL aircraft platform that is inherently stable, capable of transitional and high speed horizontal flight, safe for ground personnel and easily directed/piloted. In its preferred embodiment the aircraft would employ 3 ducted fans mounted in a blended wing/lifting body structure, the fans would only be exposed (covers open) when the aircraft was in a VTOL mode. After transitioning to a horizontal flight mode the fans would shut down and the covers would close to maintain minimal aerodynamic drag. During a conventional take-off the fans would not be utilized.

In yet another embodiment of this invention, the aircraft would have no transitional flight capability and would have limited horizontal flight capabilities (similar to a helicopter). This invention while not unique in its flight envelope HOVTOL, differs substantially from previous prior art, in its overall platform (3 independently variable, thrust ducted fans) and transitional flight capability as well as its flexible operator control options (remote-autotonomous-piloted or any variation thereof).

### BRIEF DESCRIPTION OF THE DRAWINGS

FIG. 1 is an aft perspective view of the aircraft.

FIG. 2 is a top view of the aircraft.

FIG. 3 is a side view of the aircraft.

FIG. 4 is a front view of the aircraft.

### DETAILED DESCRIPTION OF THE PREFERRED EMBODIMENT

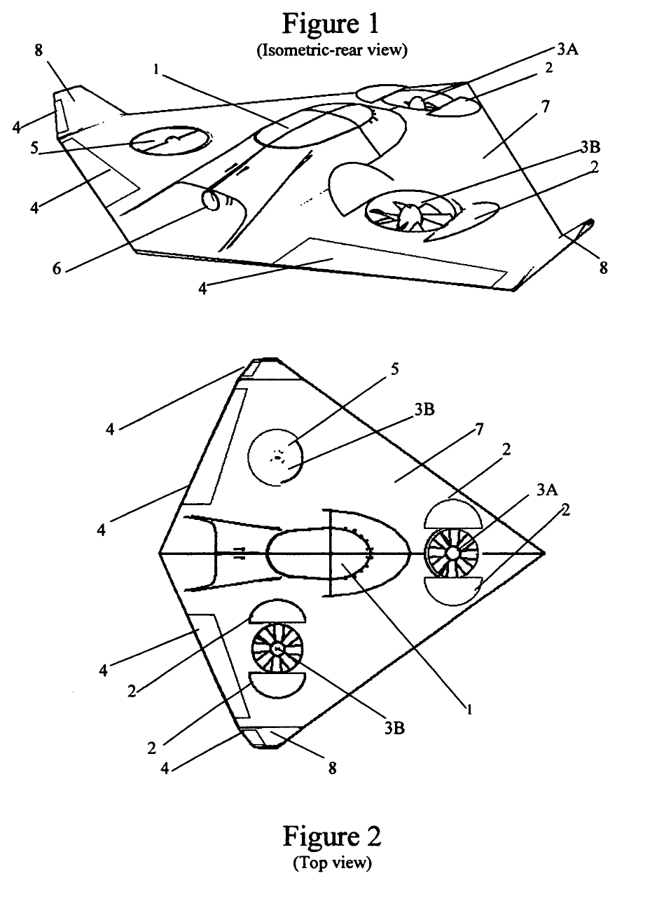

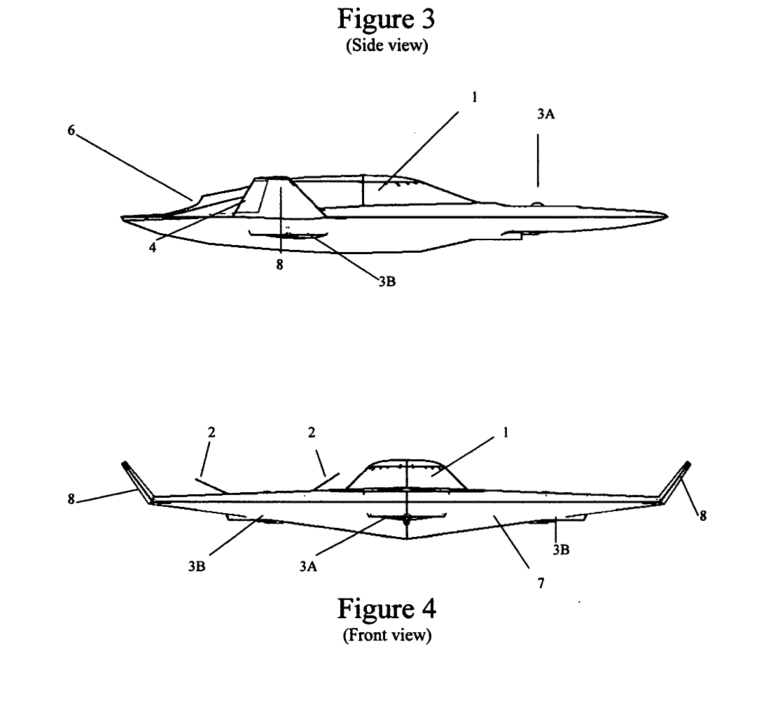

FIGS. 1 through 4 depict a preferred embodiment of the said invention that utilizes three ducted fans for vertical lift (FIG. 1-4, detail 3A and 3B). This embodiment also includes an additional power plant for forward thrust (detail 6) for use when in a horizontal flight mode. For aerodynamic streamlining while operating in a horizontal flight mode, fan duct covers are depicted in an open (detail 2) and closed (detail 5) positions. This embodiment also includes lifting surfaces or wings (detail 7) and vertical stabilizers (detail 8) for horizontal flight operation. For 3 axis control (roll-pitch-yaw) while operating in a horizontal flight mode, moveable control surfaces are included (detail 4). This aircraft also includes an integral payload or cargo area (detail 1).

This embodiment as described in FIG. 1 through 4 depicts a aircraft that utilizes 3 ducted fans for horizontal take-off and landings. To maintain 3 axis control while in vertical flight mode, the thrust from each ducted fan is selectively varied and vectored. This aircraft, as depicted, utilizes a power plant for forward thrust to transition from vertical flight to horizontal flight mode, supported by lifting surfaces (wings) while in this mode of operation. Conventional control surfaces are used to maintain 3 axis control while in horizontal flight mode.

Logistic control and the functional flight operation of this depicted aircraft is maintained thru, but not limited to, a remotely piloted control system. It's navigational and stability system include autonomous and remotely actuated features, including (but not limited to); GPS navigation systems, computer assisted gyroscope, infra-red stability and ground orientation features.

This embodiment as depicted includes a payload or cargo hold that might contain, but is not limited to, any combination of instruments, sensors, weapons and or cargo.

This invention might be used as conventional human transportation or be scaled down and used as a toy or amusement item. Its probable use would an unmanned HOVTOL platform, supporting an unlimited variety of hazardous or redundant utilitarian air-vehicle responsibilities and functions.

What is claimed is:

1. A computer assisted, Vertical Take-off and landing flight vehicle, comprising of a rigid, light weight structure wherein multiple horizontal facing, ducted multi-bladed rotary fans (or shrouded propellers) are positioned about the said structure, so as to place at least 2 of the said ducted-fans aft of the center of gravity and each on opposite sides relative to said structure's forward and aft running centerline, and at least 1 said ducted-fan positioned forward of said structures center of gravity.

2. A flight vehicle according to claim 1, that includes 2 said ducted-fans positioned aft of the said air vehicle's center of gravity and 1 said ducted-fan positioned forward of said air vehicle's center of gravity.

3. A flight vehicle according to claim 2, where said vehicle's 3 axis, roll-pitch and yaw movements, vertical and horizontal flight, vertical take-offs and landings are accomplished by coordinated differential ducted-fan thrust and diverted thrust augmentations.

4. A flight vehicle according to claim 3, that includes a method of selectively varying and or vectoring the thrust created by each said ducted-fan.

5. A flight vehicle according to claim 4 that includes a method for diverting the thrust of at least one of the said ducted-fans.

6. A flight vehicle according to claim 5, that includes an on board flight and navigation computer system that can operate said vehicle's flight, navigation and autonomous functions.

7. A flight vehicle according to claim 6, that includes at least one power-plant, transmission and drive train, supported by said air vehicle's structure, to generate and transfer adequate power and torque to develop the thrust and lift required to lift and maneuver the said air vehicle through its entire flight envelope.

8. A flight vehicle according to claim 7, that includes at least 1 power-plant that is dedicated to forward propulsion when in a conventional, horizontal flight mode and or a transitional flight mode

9. A flight vehicle according to claim 7, that can transition from direct ducted-fan lift supported flight, to a conventional type, horizontal flight mode.

10. A flight vehicle according to claim 9, that includes aerodynamic lifting planes, also known as wings, that are positioned about said structure as to create sufficient lift to sustain flight while in a conventional type, horizontal flight mode and permit conventional take-offs and landings.

11. A flight vehicle according to claim 10, that utilizes horizontal and vertical aerodynamic stabilizing surface planes to maintain stability while in a conventional type, horizontal flight mode.

12. A flight vehicle according to claim 11, that utilizes moveable aerodynamic control surfaces to control and maneuver in 3 axis while in a conventional type, horizontal flight mode.

13. A flight vehicle according to claim 12, that includes a method for covering the said ducted-fan's inlet and outlet openings to reduce aerodynamic drag while in a conventional type, horizontal flight mode

14. A flight vehicle according to claim 13, that can transport, deploy and utilize a payload in any combination of human cargo, hardware, supplies, instruments and weapons in and about said air vehicle's structure.

15. A flight vehicle according to claim 14 that can be operated remotely.

16. A flight vehicle according to claim 14 that can be operated autonomously.

17. A flight vehicle according to claim 14, that can be directly piloted

18. A flight vehicle according to claims 14, that can be operated either remotely, autonomously or can be directly piloted and any combination thereof.

19. A flight vehicle according to claim 15 that is an unmanned air vehicle.

20. A flight vehicle according to claim 16 that is an unmanned air vehicle.

21. A flight vehicle according to claim 17 that is an unmanned air vehicle.

22. A flight vehicle according to claim 18 that is an unmanned air vehicle.

23. A flight vehicle according to claim 13 that is an unmanned air vehicle.

24. A flight vehicle according to claim 22, that utilizes only said vehicle's ducted-fans for lift throughout said vehicle's entire flight envelope.

25. A flight vehicle according to claim 7, that utilizes only said vehicle's ducted-fans for lift throughout said vehicle's entire flight envelope.

26. A flight vehicle according to claim 25 that's purpose would be for amusement and recreation

27. A flight vehicle according to claim 24 that's purpose would be for amusement and recreation

28. A flight vehicle according to claim 18 that's purpose would be for human transportation

29. A flight vehicle according to claim 24 that's purpose would be for human transportation
